(19) United States
(12) Patent Application Publication
(10) Pub. No.: US 2003/0094056 A1
(43) Pub. Date: May 22, 2003

(54) Anti-backlash screw and nut assembly

(76) Inventor: Kyi Hwan Park, Gwanglu (KR)

Correspondence Address: NIXON & VANDERHYE P.C., 8th Floor, 1100 North Glebe Road, Arlington, VA, 22201-4714, US

(21) Appl. No.: 10/218,462

(22) Filed: Aug. 15, 2002

(30) Foreign Application Priority Data
Nov. 20, 2001 (KR) 2001-72417

(51) Int. Cl. F16H 25/20

(52) U.S. Cl. 74/89.42

(57) ABSTRACT

Disclosed is an anti-backlash screw and nut assembly adapted for converting rotational motion into linear motion. The assembly comprises a screw rotated by a motor; first and second nut blocks threadedly coupled with the screw to be linearly moved, the second nut block being formed on an upper surface thereof with an insertion pin; a pair of springs for connecting and applying compression or tensile force to the first and second nut blocks in a manner such that flanks of threads of the screw and the nut blocks can be brought into contact with each other while not causing backlash; and a plate member secured to an upper surface of the first nut block by fastening bolts and defined with a slot in which the insertion pin of the second nut block is inserted to be moved therealong.

### BACKGROUND OF THE INVENTION

1 Field of the Invention

The present invention relates to an anti-backlash screw and nut assembly which serves as a mechanical element adapted for converting rotational motion into linear motion.

2. Description of the Related Art

Generally, as mechanical elements for converting rotational motion into linear motion, a screw and nut assembly, a rack and pinion assembly, and the like, have been widely used.

While a plurality of mechanical elements are used to construct a control system, an operational accuracy of a precision control system is deteriorated due to backlash induced at a final operation stage. Backlash is caused by relative movement of mechanical elements, which results from incomplete coupling of the mechanical elements. In a system having backlash, as a dead operating zone is produced, a limitation is necessarily imposed to the attempt for high precision control, and noise is generated in the mechanical elements which are incompletely coupled.

In the case that a driving source is rotated, upon converting rotational motion into linear motion, operational precision is adversely influenced further by backlash rather than by mechanical frictional force. For this reason, it is impossible to accomplish high operational precision by using the conventional screw and nut assembly. That is to say, when a voltage is applied to an electric motor and thereby a screw is rotated, if a single nut block is used, backlash is caused since the screw and nut block are not brought into full mechanical contact with each other.

Also, while a nonlinear backlash-reducing method has been disclosed in the art, the method has inherent restrictions, and was proved less effective than a method of mechanically eliminating backlash.

Referring to FIG. 1, there is shown a cross-sectional view illustrating a conventional anti-backlash screw and nut assembly. In the conventional assembly, balls b are interposed between a screw 1 and a nut block 2 to generate a preload. Owing to the preload, the screw 1 and the nut block 2 can be brought into close contact with each other. However, the conventional anti-backlash screw and nut assembly has a disadvantage in that assemblability is not easy and a manufacturing cost is increased.

### SUMMARY OF THE INVENTION

Accordingly, the present invention has been made in an effort to solve the problems occurring in the related art, and an object of the present invention is to provide an inexpensive anti-backlash screw and nut assembly which serves as a mechanical element adapted for converting rotational motion of a screw rotated by a motor into linear motion of nut blocks threadedly coupled with the screw, while perfectly eliminating backlash and thereby ensuring precise operation of the screw.

In order to achieve the above object, according to the present invention, two nut blocks are employed in a manner such that they are threadedly coupled with a screw and connected with each other by a pair of springs.

### BRIEF DESCRIPTION OF THE DRAWINGS

The above objects, and other features and advantages of the present invention will become more apparent after a reading of the following detailed description when taken in conjunction with the drawings, in which:

FIG. 1 is a cross-sectional view illustrating a conventional anti-backlash screw and nut assembly;

FIG. 2 is a perspective view illustrating an anti-backlash screw and nut assembly in accordance with an embodiment of the present invention;

FIG. 3 is a plan view illustrating the anti-backlash screw and nut assembly according to the present invention;

FIG. 4 is a front view illustrating the anti-backlash screw and nut assembly according to the present invention;

FIG. 5 is a side view illustrating the anti-backlash screw and nut assembly according to the present invention; and

FIG. 6 is a front cross-sectional view illustrating a state wherein a screw threadedly passes through nut blocks in the anti-backlash screw and nut assembly according to the present invention.

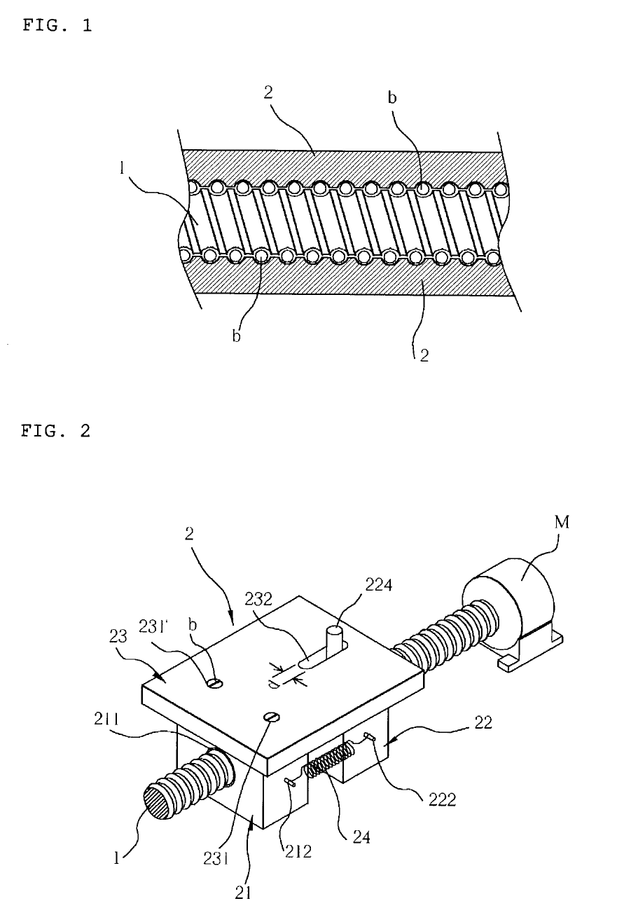

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

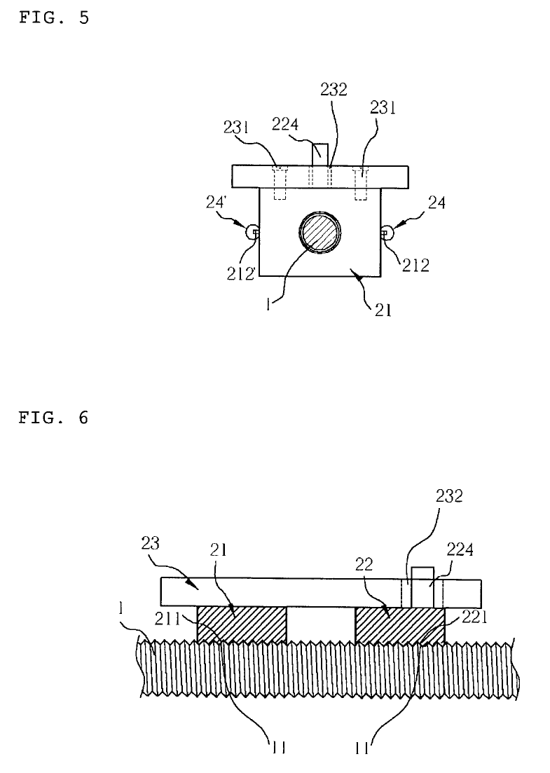

Referring to FIG. 2, an anti-backlash screw and nut assembly in accordance with an embodiment of the present invention comprises a screw 1 and a linear movement body 2. The screw 1 is rotated by a motor M and formed on a circumferential outer surface thereof with threads. The linear movement body 2 can be linearly moved by rotation of the screw 1. As can be readily seen from FIGS. 2 through 6, the linear movement body 2 includes first and second nut blocks 21 and 22, a plate member 23 and a pair of springs 24 and 24′. The first and second nut blocks 21 and 22 are respectively defined with threaded holes. The plate member 23 is rested on upper surfaces of the nut blocks 21 and 22.

The plate member 23 is defined with a pair of bolt holes 231 and 231′ and a slot 232.

Two pairs of support lugs 212 and 222 are formed on both side surfaces of the first and second nut blocks 21 and 22 in a manner such that both ends of the springs 24 and 24′ can be hooked on the support lugs 212 and 222, respectively.

The plate member 23 is secured to the upper surface of the first nut block 21 by fastening bolts b. An insertion pin 224 is formed on the upper surface of the second nut block 22 in a manner such that it can be inserted into the slot 232 defined in the plate member 23.

Upon assembling the screw 1 and the linear movement body 2 with each other, the screw 1 is threadedly driven through the threaded holes of the first and second nut blocks 21 and 22, and the plate member 23 is secured to the first nut block 21 by the fastening bolts b. The insertion pin 224 of the second nut block 22 is inserted into the slot 232 defined in the plate member 23 to be linearly moved therein while prevented from being rotated.

Both ends of the springs 24 and 24′ are respectively hooked on the two pairs of support lugs 212 and 222.

The screw 1 has a round bar-shaped configuration and is formed on the circumferential outer surface thereof with the threads. The screw 1 is connected at one end thereof to the motor M to be rotatingly driven thereby.

If the screw 1 is rotated, the linear movement body 2 is linearly moved along an axis of the screw 1.

The anti-backlash screw and nut assembly according to the present invention employs two nut blocks 21 and 22. The first and second nut blocks 21 and 22 are connected with each other by the pair of tension springs 24 and 24′ so that compression force is applied to the nut blocks 21 and 22. By this fact, as shown in FIG. 6, flanks 11, 211 and 221 of the threads of the screw 1 and the nut blocks 21 and 22 are brought into contact with each other. That is to say, by the action of the compression force, since the flanks 11, 211 and 221 of the threads of the screw 1 and the nut blocks 21 and 22 are brought into contact with each other without undergoing play, backlash is not caused upon movement of the linear movement body 2.

Reliable contact between the flanks 11, 211 and 221 of the threads of the screw 1 and the nut blocks 21 and 22 is maintained even when a rotating direction of the screw 1 is changed. At this time, when the driving motor M is rotated, in order to prevent the second nut block 22 from being rotated, adjacent to one end of the plate member 23, the slot 232 is defined through the plate member 23 in a manner such that the insertion pin 224 of the second nut block 22 is inserted into the slot 232 to be linearly moved therein while prevented from being rotated.

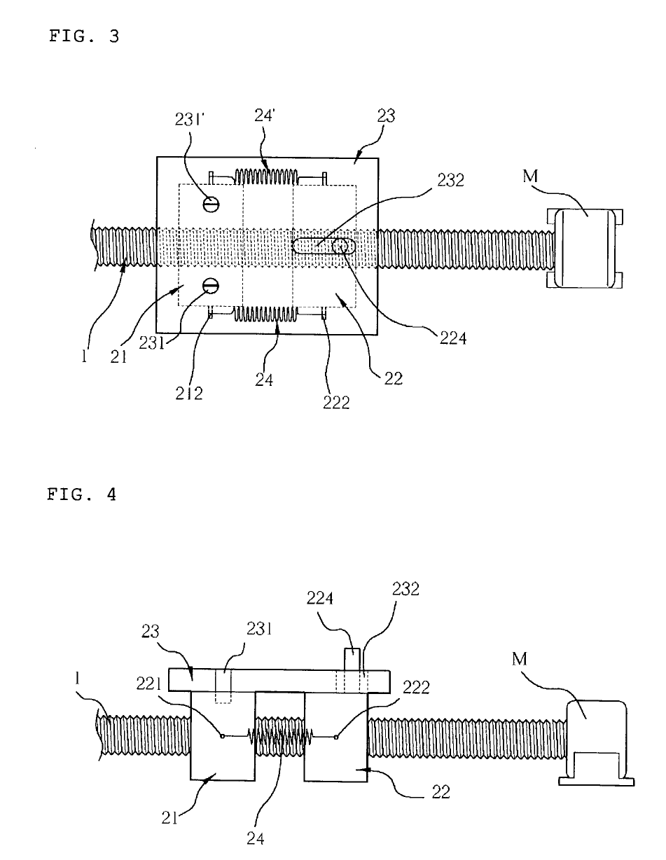

FIGS. 3 through 5 are respectively a plan view, a front view and a side view illustrating the anti-backlash screw and nut assembly according to the present invention. In a state wherein the first and second nut blocks 21 and 22 are spaced apart from each other by a predetermined distance, by respectively hooking both ends of the tension springs 24 and 24′ on the two pairs of support lugs 212 and 222 which are formed on both side surfaces of the first and second nut blocks 21 and 22, the first and second nut blocks 21 and 22 are connected with each other and are applied with compression force. The insertion pin 224 is projectedly formed on the upper surface of the second nut block 22 in a manner such that it can be inserted into the slot 232 defined in the plate member 23. The plate member 23 is secured to the first nut block 21 by the fastening bolts b. A width d of the slot 232 defined in the plate member 23 is determined to be slightly greater than a diameter of the insertion pin 224, in a manner such that the insertion pin 224 can be loosely fitted into the slot 232. At this time, an allowance between the insertion pin 224 and the slot 232 is set to a low value so that the insertion pin 224 is prevented from being rotated upon rotation of the screw 2 by the motor M. The slot 232 of the plate member 23 ensures that the insertion pin 224 of the second nut block 22 is linearly moved therein along the axis of the screw 1. Due to the fact that the tension springs 24 and 24′ apply compression force to the first and second nut blocks 21 and 22, the flanks 11, 211 and 221 of the threads of the screw 1 and the nut blocks 21 and 22 are reliably brought into contact with each other while not causing any backlash.

As a result, the anti-backlash screw and nut assembly according to the present invention has structural features as described below. At least two nut blocks are used to constitute a linear movement body. First and second nut blocks are connected with each other by a pair of springs in a manner such that compression or tensile force is applied to the first and second nut blocks, and thereby, flanks of threads of a screw and the nut blocks are reliably brought into contact with each other. A slot is defined in a plate member and an insertion pin to be inserted into the slot is formed on one nut block in a manner such that the nut block can be linearly moved in the slot while prevented from being rotated upon rotation of the screw.

As apparent from the above description, the anti-backlash screw and nut assembly according to the present invention, constructed as mentioned above, provides advantages in that, since it does not cause any backlash, it can be used for precise operation control. In the conventional art, upon converting rotational motion into linear motion, because operational precision is adversely influenced further by backlash rather than by mechanical frictional force, it is impossible to accomplish high operational precision by using the conventional screw and nut assembly. Also, while a nonlinear backlash-reducing method has been disclosed in the art, the method has inherent restrictions, and was proved less effective than a method of mechanically eliminating backlash. In consideration of these facts, the present invention allows high operational precision to be accomplished through simple control.

Further, the anti-backlash screw and nut assembly according to the present invention can be easily manufactured and assembled with a reduced cost when compared to the conventional assembly using a ball screw.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. An anti-backlash screw and nut assembly adapted for converting rotational motion into linear motion, comprising:
a screw rotated by a motor;
first and second nut blocks threadedly coupled with the screw to be linearly moved, the second nut block being formed on an upper surface thereof with an insertion pin;
a pair of springs for connecting and applying compression or tensile force to the first and second nut blocks in a manner such that flanks of threads of the screw and the nut blocks can be brought into contact with each other while not causing backlash; and
a plate member secured to an upper surface of the first nut block by fastening bolts and defined with a slot in which the insertion pin of the second nut block is inserted to be moved therealong.
